(19) United States
(12) Patent Application Publication
(10) Pub. No.: US 2012/0001659 A1
(43) Pub. Date: Jan. 5, 2012

(54) Voltage-to-Current Converter with Feedback

(75) Inventor: Pio Balmelli, Austin, TX (US)

(73) Assignee: SILICON LABORATORIES, INC., Austin, TX (US)

(21) Appl. No.: 12/828,083

(22) Filed: Jun. 30, 2010

(51) Int. Cl. H02M 11/00

(52) U.S. Cl. 327/103

(57) ABSTRACT

A voltage-to-current converter includes a transconductance stage including an input configured to receive a scaled voltage signal, a first output to carry a first current based on the scaled voltage signal, and a second output to carry a second current that is proportional to the first current. The voltage-to-current converter further includes a digital feedback loop coupled to the second output of the transconductance stage and configured to adjust the scaled voltage signal based on an error between an external reference voltage and a sense voltage derived from the second current to compensate for changes in the scaled voltage signal.

### FIELD

The present disclosure is generally related to voltage-to-current converters, and more particularly to voltage-to-current converters with feedback for calibration.

### BACKGROUND

A voltage-to-current converter, also commonly called a transconductance amplifier, is a circuit configured to perform a conversion of an input voltage signal into an analog output current signal. Such voltage-to-current converters are used in a large variety of circuits, including active filters, analog-to-digital converters, delta-sigma modulators, multipliers, oscillators, integrators, mixers, and other circuits.

Linearity of such voltage-to-current converters over a wide range of input voltages is desirable. Specifically, in order to satisfy a signal-to-noise and distortion ratio required by a system, the linear input/output range should be wide and maintain a predetermined input/output gain within a desired frequency range. In particular, when the power supply is used to provide an input to a transconductance stage, power supply drift, such as that caused by battery discharge, can cause the transconductance stage to go out of range, affecting the linearity of the transconductor stage.

### BRIEF DESCRIPTION OF THE DRAWINGS

FIG. 1 is a block diagram of a switching amplifier including predictive feedback compensation circuitry for pulse width adjustment that uses a voltage-to-current converter with feedback based on a pulse width reference input signal.

FIG. 2 is a block diagram of a switching amplifier including predictive feedback compensation circuitry for pulse width adjustment that uses a voltage-to-current converter with feedback based on a compensated pulse width signal.

FIG. 3 is a partial circuit and partial block diagram of an embodiment of a voltage-to-current converter with feedback, which can be used, for example, in the switching amplifiers of FIGS. 1 and 2.

FIG. 4 is a partial circuit and partial block diagram of another embodiment of the voltage-to-current converter of FIG. 3 including a dither circuit.

FIG. 5 is a circuit diagram of an embodiment of a circuit for providing predictive feedback compensation with open loop pulse width adjustment that uses a voltage-to-current converter with background calibration, such as those illustrated in FIGS. 1-4, as a high pass filter.

FIG. 6 is a block diagram of an embodiment of a circuit configured to adjust pulse widths of a signal based on an uncompensated voltage signal.

FIG. 7 is a block diagram of an embodiment of a circuit configured to adjust pulse widths of a signal based on a compensated output signal.

FIG. 8 is a timing diagram depicting the relatively high frequency (ac) and relatively low frequency (dc) signal components of the pulse widths in the embodiments of the circuits depicted in FIGS. 6 and 7.

FIG. 9 is a diagram of an embodiment of a transconductance circuit configured to receive a scaled voltage signal and to generate first and second currents using a current mirror configuration.

FIG. 10 is a diagram of a second embodiment of a transconductance circuit configured to receive a scaled voltage signal and to generate first and second currents using a parallel amplifier configuration.

In the following description, the use of the same reference numerals in different drawings indicates similar or identical items.

### DETAILED DESCRIPTION OF ILLUSTRATIVE EMBODIMENTS

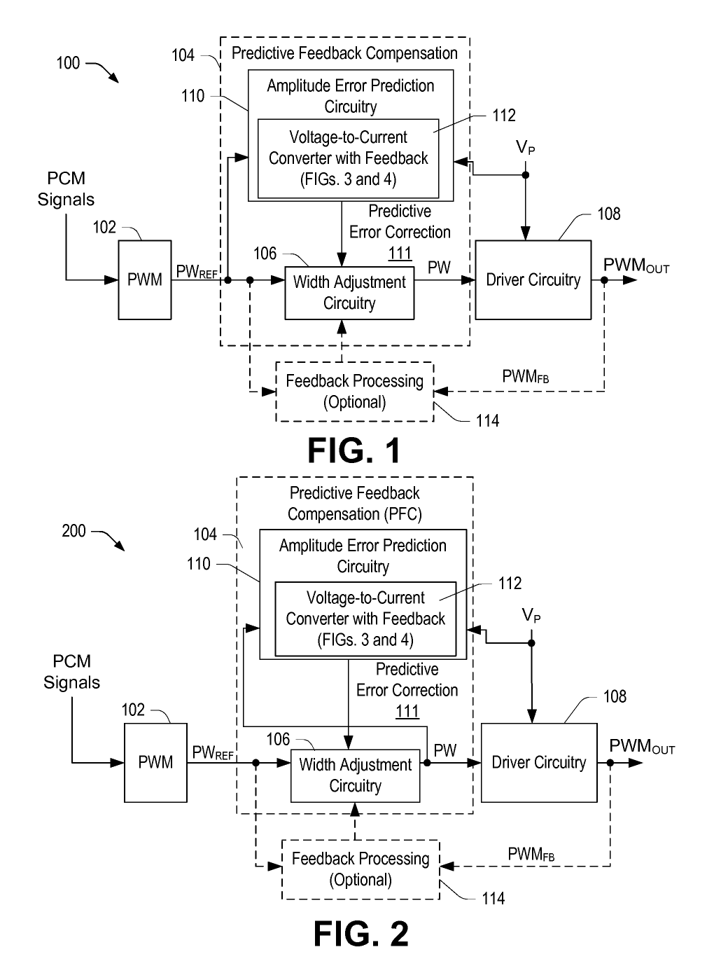

Embodiments of a transconductance amplifier with background calibration are described below that are configurable to convert a voltage signal with noise into a current signal with better than point-one percent (0.1%) linearity even when the signal itself slowly drifts between voltages (such as from 6.6 Volts to 3 Volts due to battery discharge). This transconductance amplifier can be used to replace a standard transconductance amplifier and/or, in some instances, can be used to replace a high pass filter to provide substantially linear operation over a wide range of amplitudes. In a particular embodiment described below with respect to FIGS. 1, 2 and 5, the transconductance amplifier with background calibration is used in a pulse-width modulation compensation scheme that modifies the signal pulse width in order to compensate for supply noise changes.

FIG. 1 is a block diagram of a switching amplifier 100 including predictive feedback compensation (PFC) circuitry 104 for pulse width adjustment that uses a voltage-to-current converter with feedback 112 based on a pulse width reference input signal (PW_{REF}). Audio pulse code modulated (PCM) signals are received by a PWM controller 102, which is connected to width adjustment circuitry 106 for providing the uncompensated output of the PWM controller 102. Width adjustment circuitry 106 in turn provides width adjusted PWM signals to driver circuitry 108, which produces pulse width modulated (PWM) output signals (PWM_{OUT}), for example, in the form of B-pulse (B) output signals and D-pulse (D) output signals for a Class D digital audio PWM switching amplifier.

Driver circuitry 108 is configured to receive power from supply voltage (V_{P}). Unfortunately, the supply voltage (V_{P}) can have variations in the frequency band of interest that lead to amplitude errors in the PWM output signals, and these errors can translate into distortion and noise in the audio output heard by a user for Class D digital audio switching amplifiers. To compensate for these amplitude errors, amplitude error prediction circuitry 110 is connected to the output for receiving the PWM output signals and is configured to generate a predictive error correction signal 111, which is provided to the width adjustment circuitry 106 to compensate the error by adjusting the width of the pulses. Further, the supply voltage (V_{P}) can experience slow amplitude drift (relatively low frequency variations), which can be due, for example, to the discharge of the battery power supply and which can also contribute to amplitude errors in the PWM output signals. However, this error is not in the audio band, and therefore it does not translate into distortion or noise. As a result, the error does not need to be compensated. PFC circuitry 104 includes a voltage-to-current converter with feedback 112, which is configured to filter such low frequency variations.

The amplitude error prediction circuitry 110 can use the voltage-to-current converter with feedback 112 as a high pass filter and/or as part of a transconductance stage for producing the predictive error correction signal 111. In particular, the amplitude error prediction circuitry 110 receives the supply voltage (V_{P}) and the PWM input signals (PW_{REF}) from the PWM controller 104, processes the PWM input signals and the supply voltage (V_{P}) to produce the error correction signal 111. The width adjustment circuitry 106 and the amplitude error prediction circuitry 110 form the PFC circuitry 104. If desired, optional feedback processing circuitry 114 can also be provided. For example, a feedback signal from PWM output signal (PWM_{OUT}) and a reference signal from the input (PW_{REF}) can be provided to the feedback processing circuitry 114, which can compare the input to the feedback and provide a feedback error correction signal to the width adjustment circuitry 106 within the PFC circuitry 104. This allows the PFC circuitry 104 to be used in conjunction with feedback systems.

While the embodiment shown in FIG. 1 uses the input signal (PW_{REF}) as one of the inputs to the amplitude error prediction circuitry 110, it should be understood that other signals may be used. For example, the compensated signal (PW) at the output of width adjustment circuitry 106 may be used as illustrated with respect to the switching amplifier of FIG. 2.

FIG. 2 is a block diagram of a switching amplifier 200 including predictive feedback compensation circuitry 104 for pulse width adjustment that uses a voltage-to-current converter with feedback 112 based on a compensated pulse width signal. In the embodiment depicted in FIG. 2, the elements are the same as in FIG. 1, except that the predictive error correction signal 111 is produced based on the supply voltage (V_{P}) and the compensated PW signal at the output of the width adjustment circuitry 106.

While FIGS. 1 and 2 have illustrated using supply voltage (V_{P}) and either the uncompensated PW_{REF} signal or the compensated PW signal to produce the predictive error correction signal 111, other inputs may also be used. In an alternative embodiment (not shown), the predictive error correction signal 111 may be produced using the PWM_{OUT} signal and either the uncompensated PW_{REF} signal or the output signal PWM_{OUT}.

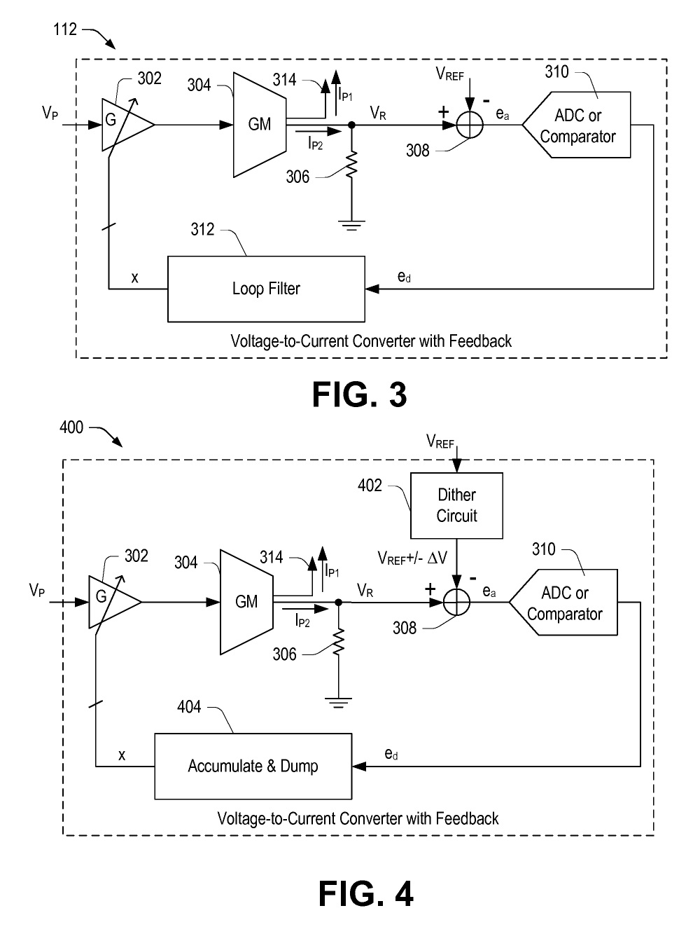

The embodiments of the switching amplifiers 100 and 200 depicted in FIGS. 1 and 2 provide for compensation of the pulse width based upon output amplitude errors through the detection and measurement of voltage supply errors or direct measurement of the amplitude of the output pulse itself. The voltage-to-current converter with feedback circuit 112 is configured to convert power supply voltage noise into a current signal with better than 0.1% linearity where the power supply can slowly drift. An embodiment of the voltage-to-current converter with feedback 112 is described below with respect to FIG. 3.

FIG. 3 is a partial circuit and partial block diagram of an embodiment of voltage-to-current converter with feedback 112, such as described above with respect to FIGS. 1 and 2. Voltage-to-current converter 112 includes a digitally programmable gain amplifier (PGA) 302 connected to a transconductance stage 304. Transconductance stage 304 includes an output connected to a first input of a summing device 308. Summing device 308 includes a second input for receiving a reference voltage (V_{REF}) and an output that is connected to an analog-to-digital converter 310, which includes an output that is connected to a digital loop filter 312. Digital loop filter 312 includes an output connected to a control input of PGA 302.

PGA 302 receives a supply voltage (V_{P}) (or some other voltage signal) and multiplies the supply voltage (V_{P}) by a gain (G) that is a function of a digital code (x) received at the control input. In an embodiment, the digital code (x) is a multi-bit word configured to adjust the gain of PGA 302 to produce a scaled voltage signal. The transconductance stage 304 converts the scaled voltage signal into a current (I_{P1}), which may be a supply current that can be provided to associated circuitry, such as the amplitude error prediction circuitry 110 depicted in FIG. 1.

Further, the transconductance stage 304 copies the supply current (I_{P1}) to produce a second current (I_{P2}), which is applied to a sense resistor 306 to generate a sense voltage (V_{R}). The sense voltage can be combined with an externally generated reference voltage (V_{REF}) at a summing device 306 to produce an analog error (eₐ). The analog error (eₐ) is provided to an analog-to-digital converter (ADC) 310, which converts the analog error (eₐ) into a digital error (e_{d}) and provides the digital error (e_{d}) to loop filter 312. Loop filter 312 accumulates the digital error (e_{d}) over time and generates a digital code (x), which controls the gain (G) of PGA 302.

In the illustrated embodiment, the gain bandwidth of the loop filter 312 determines the system bandwidth. Any change in the voltage signal (V_{P}) within the system bandwidth is invisible to the transconductance stage 304, since the loop filter 312 will adjust the gain (G) to maintain the analog error (eₐ) at approximately zero and hence keep the scaled voltage signal at the input of the transconductance stage 304 substantially constant. Thus, in an embodiment, the transconductance stage 304 can be substantially optimized to track relatively fast but small voltage signal changes, while the digital feedback loop provided by ADC 310 and loop filter 310 ensures that a relatively slow but large drift in amplitude of the voltage signal (V_{P}) is compensated.

In the illustrated embodiment, PGA 302 is responsive to a multi-bit control word, such as a five-bit control word (x), and the ADC 310 has a resolution of one-bit. In a particular embodiment, ADC 310 can be implemented as a comparator. Further, in some embodiments, PGA 302 can be implemented as an attenuator using a simple resistive divider circuit to receive the input voltage signal.

The transconductance stage 304 is an active circuit, and its offsets directly affect the linearity of the supply current (I_{P1}) and the second current (I_{P2}). ADC 310 and loop filter 312 cooperate to provide an effective transconductance (GM_{eff}) that is proportional to one over the voltage signal (V_{P}) according to the following equation:

$${GM}_{eff} = \frac{{I}_{P}}{{V}_{P}} = \frac{1}{{V}_{P}} * \frac{{V}_{REF}}{{R}_{306}} \qquad ( 1 )$$

Thus, voltage-to-current converter 112 achieves a desired characteristic, namely that the amount of correction of the pulse width is also proportional to the inverse of the voltage signal (V_{P}). If the voltage signal is the supply voltage, then the amount of correction is proportional to the inverse of the supply voltage. If the gain of the PGA 302 is known, it is possible to calculate the average of the voltage signal (V_{P}_{_{—}}_{AVE}) from the digital code word (x). Thus, voltage-to-current converter 112 can operate as a voltage signal digitizer.

Voltage-to-current converter 112 converts a voltage signal, such as an internal representation of the power supply into a current signal with better than 0.1% linearity where the power supply can slowly drift from a first voltage level to a second voltage level. In a particular example, where the power supply is a battery and where the battery supplied voltage level decreases slowly over time, for example, from 6.6 Volts to 3 Volts, the feedback compensation circuit is configured to modify the signal pulse width to provide substantial linearity even with power supply drift.

The voltage-to-current converter 112 provides such linearity with less power consumption and less circuit area than a converter using a “brute force” digital approach requiring an analog-to-digital converter and a digital-to-analog converter with more than 12-bit resolution of combined Signal to Noise-plus-Distortion Ratio (SNDR). Further, voltage-to-current converter 112 provides such linearity with less power consumption and less circuit area than a converter using a “brute force” analog approach that would require 60 dB of linearity over a very wide range.

In the illustrated embodiment, the accumulator in the feedback path can create limit cycles causing the digital code word (x) to continuously change, even if the voltage signal (V_{P}) is not changing. In such an instance, it may be desirable to replace the accumulator in the feedback path with an accumulate and dump block 404 and to inject noise, using dither circuit 402, into the summing device 308 along with the reference voltage (V_{REF}) to enhance the resolution of the ADC 310 and loop filter 312. An example of such a modification is described below with respect to FIG. 4.

FIG. 4 is a partial circuit and partial block diagram of another embodiment of a voltage-to-current converter with feedback 400, which is the same as the voltage-to-current converter 112 described above with respect to FIG. 3, except that it includes a dither circuit 402 and an accumulate and dump block 404. Dither circuit 402 is configured to inject noise (plus or minus ΔV) into summing node 308 together with the reference voltage (V_{REF}). The dithering noise is chosen to be larger than half of the variation of the voltage (V_{R}) caused by one least significant bit (LSB) change of the digital word (x). The digital word (x) is then only changed when the accumulate and dump filter 404 is above or below pre-determined values. Continuous change of the digital control word (x) is avoided by choosing predetermined values that are equal to the maximum and the minimum output of the accumulate and dump filter 404.

While the discussion of FIGS. 3 and 4 referred to an externally generated reference voltage (V_{REF}), it should be understood that the reference voltage could be generated locally, such as by applying an external reference current to an on-chip resistor. In another example, the external reference current could be supplied by an external source, such as a host system coupled to a circuit that includes a predictive feedback compensation system, such as that depicted in FIGS. 1 and 2.

In some embodiments, voltage-to-current converter 112, described-above with respect to FIGS. 1-4, is used in conjunction with circuitry that includes an interface (not shown) for communicating with a host system, such as a host processor. In such embodiments, loop filter 312 can communicate the digital code word (x) to the associated circuitry, which provides the digital code word (x) to the host system. By communicating the digital code word (x) to the host system, it is possible to make the supply drift compensation functionality programmable. In a particular instance, the supply drift compensation function may be activated through a firmware command, which can be provided to the system, for example, when the supply voltage is intentionally changed. In one particular embodiment, the firmware command enables the loop filter 312 and ADC 310 to provide supply drift compensation functionality in such a way as to withstand a large supply step without interruption of the operation of the system.

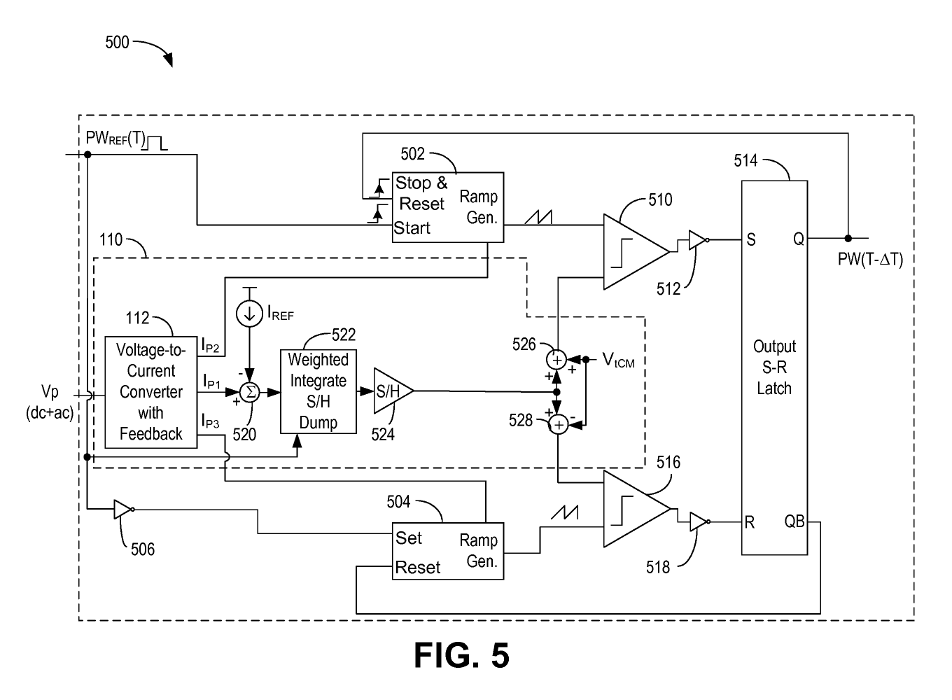

FIG. 5 is a circuit diagram of a single-ended embodiment of a circuit 500 for providing predictive feedback compensation with open loop pulse width adjustment that uses a voltage-to-current converter with feedback 112, such as those illustrated in FIGS. 1-4, as a high pass filter. Circuit 500 further includes an embodiment of amplitude error prediction circuitry 110, such as that depicted in FIGS. 1 and 2.

Circuit 500 includes ramp generators 502 and 504. Ramp generator 502 receives the PW_{REF}(T) signal and generates a ramp signal based on the PW_{REF}(T) signal rising edge and the supply voltage (V_{P}(dc+ac)) signal. Ramp generator 502 is connected to a first input of a comparator 510, which includes a second input connected to the amplitude error prediction circuitry 110 and an output connected to an inverter 512. Inverter 512 includes an output connected to an S-input of an output set-reset (S-R) latch 514. Output S-R latch 514 includes a Q-output for providing a compensated output signal (PW(T−ΔT)), an R-input, and a Q-B-output for providing an inverted version of the compensated output signal. The Q-output is connected to ramp generator 502. The Q-B output is connected to ramp generator 504.

Ramp generator 504 includes an input for receiving an inverted version of the PW_{REF}(T) signal from inverter 506. Ramp generator 504 generates a ramp signal and provides the ramp signal to a first input of comparator 516, which includes a second input connected to amplitude error prediction circuitry 110 and an output connected to inverter 518. Inverter 518 includes an output connected to the R-input of output S-R latch 514.

Amplitude error prediction circuitry 110 includes voltage-to-current converter with feedback 112, which receives the supply voltage (V_{P}(dc+ac)). The supply voltage (V_{P}(dc+ac)) includes both ac and dc noise components. Voltage-to-current converter with feedback 112 produces a current (I_{P1}) based on the supply voltage (V_{P}(dc+ac)) and provides the current (I_{P1}) to an input of a summing device 520. Summing device 520 includes a second input for receiving a reference current (I_{REF}). Summing device 520 subtracts the reference current (I_{REF}) from the current (I_{P1}) to generate a difference current and provides the difference current to weighted integrate sample/hold and dump circuit 522. Weighted integrate sample/hold and dump circuit 522 processes the analog error (eₐ) over time in conjunction with the PW_{REF}(T) signal to produce an output and provide the output to a sample/hold circuit 524. Sample/hold circuit 524 provides the output to summing devices 526 and 528. The voltage-to-current converter with feedback 112 additionally supplies a copy of the current (I_{P1}) to each of the ramp generators 502 and 504.

Summing device 526 adds the output signal to a common mode threshold voltage (V_{tCM}) signal to produce a first threshold voltage and applies the first threshold voltage to the second input of comparator 510. The common mode threshold voltage (V_{tCM}) signal may be generated on chip or can be received from an external source, such as a host system. Summing device 528 subtracts the common mode threshold voltage (V_{tCM}) signal from the output signal from sample/hold circuit 524 to produce a second threshold voltage and provides the second threshold voltage to the second input of comparator 516.

Comparators 510 and 516 compare the ramp signals from ramp generators 502 and 504 to the first and second voltage thresholds, respectively. When the ramp signals exceed their respective threshold voltages, the comparators 510 and 516 generate pulses.

In the illustrated embodiment, ramp generator 502 and comparator 510 cooperate to delay the rising edge of the uncompensated PW_{REF}(T) signal and the ramp generator 504 and comparator 516 cooperate to delay the falling edge of the uncompensated PW_{REF}(T) signal. Output S-R latch 514 transitions in response to the delayed edges, resulting in an output pulse (PW(T−ΔT)) with a rising edge delayed by τ₁+τ_{dr}, and a falling edge delayed by τ₁+τ_{df}, where τ₁ is the bias latency, where τ_{dr} is the rising edge delay, and where τ_{df} is the falling edge delay.

In the illustrated embodiment, the non-inverted output (Q) of the S-R latch 514 is the compensated PW that is provided to the driver circuitry 108 in FIGS. 1 and 2 that has had the time (T) of its pulse width adjust by a correction factor (ΔT) so that the new pulse width is T−ΔT. The difference between the uncompensated PW_{REF} input signal (PW_{REF}(T)) and the compensated PW signal (PW) represent the pulse width adjustment used to compensate for amplitude errors in the voltage signal.

In operation, the threshold voltages include a prediction of the relatively high frequency power supply noise (i.e., the ac components of the supply voltage (V_{P})) weighted by the pulse width using the weighted integrate sample/hold and dump circuit 522. Summing devices 526 and 528 set a common mode delay for the rising edges and falling edges, respectively.

In the illustrated embodiment, the voltage-to-current converter with feedback 112 operates as a high-pass filter to remove slow but large supply voltage variations from influencing the pulse width while allowing generation of the predictive error correction based on the supply voltage including ac noise components. In general, for simplicity, it is assumed that the pulse width and relatively high frequency voltage components associated with a previous pulse represent good predictors for current values of the pulse width and current values of the high frequency voltage components. In this particular example, voltage-to-current converter with feedback 112 operates as a high pass filter to reject frequencies below approximately 10 Hz and to pass relatively high frequency noise (ac components) of the supply voltage (V_{P}).

While in the illustrated embodiment, the amplitude error prediction circuitry 110 uses the PW_{REF}(T) signal, in alternative embodiments, amplitude error prediction circuitry 110 can be reconfigured to use the pulse-width timing of the compensated PW signal. In another embodiment, the amplitude error prediction circuitry 110 can use a signal provided from an external source, such as a host system (not shown).

As compared to prior art circuits that require a unique transconductance stage for each ramp signal generator and the weighted integrate sample/hold and dump circuit 522, circuit 500 uses a single transconductance stage 112 to generate a current that can be mirrored or otherwise copied to produce currents that are used to drive the various ramp generators. Using single transconductance stage 112 consumes less circuit area and reduces design complexity as compared to circuits that include multiple transconductor stages to drive the ramp generators.

While the embodiment depicted in FIG. 5 illustrates an example of a voltage-to-current converter 112 used as a high pass filter, it should be understood that the voltage-to-current converter 112 may be used to implement a transconductance amplifier for a variety of uses. Further, it should be appreciated that the resulting current (I_{P1}) can be copied one or more times, for example by using a current mirrors to provide multiple proportional currents.

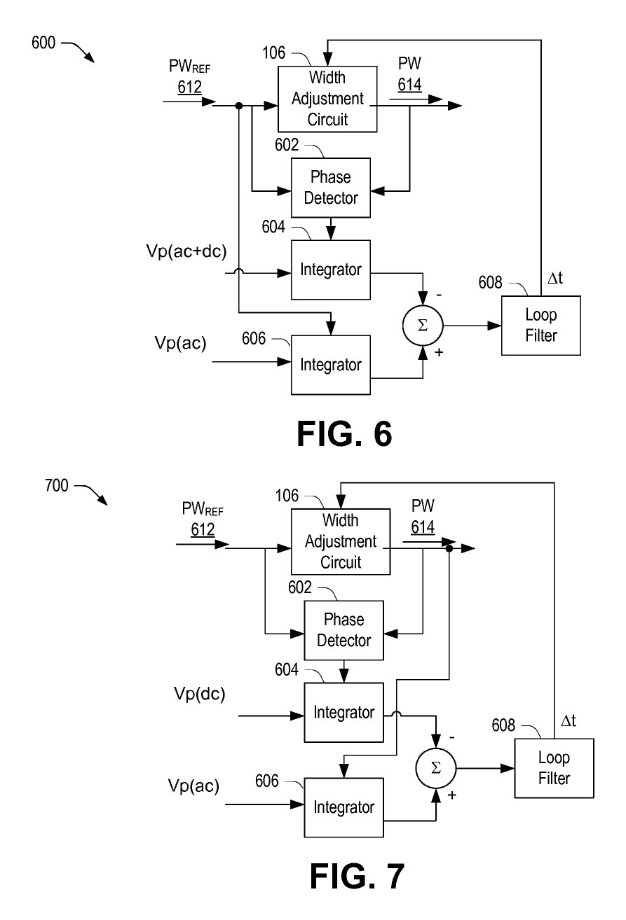

FIG. 6 is a block diagram of an embodiment of a circuit 600 configured to adjust pulse widths of a signal based on an uncompensated voltage signal. Circuit 600 includes width adjustment circuit 102 for receiving an uncompensated voltage signal, such as PW_{REF} 612, and for providing a compensated output signal, such as PW 614. Circuit 600 further includes a phase detector 602, integrators 604 and 606, a summing device, and a loop filter 608, which cooperate to control the delay of the width adjustment circuit 106.

Phase detector 602 receives the uncompensated voltage signal (PW_{REF}) 612 and compensated output signal (PW) 614 and determines a delay (Δt) between PW_{REF} 612 and PW 614. The delay (Δt) is provided to integrator 604. Integrator 604 integrates the supply voltage (V_{P}(ac+dc)) including ac and dc components over the delay (Δt). Further, integrator 606 integrates the supply voltage (V_{P}(ac)) with the dc components filtered out over the duration of the input pulse (PW_{REF}).

The summing device subtracts the output of integrator 604 from the output of integrator 606 and provides the difference, which corresponds to the pulse width error attributable to the AC noise of the supply voltage (V_{P}(ac+dc)), to loop filter 608. Loop filter 608 accumulates the pulse width error information and to generate a delay adjustment signal for controlling a delay of width adjustment circuit 106. In particular, loop filter 608 is configured to have a large gain in the frequency band of interest, ensuring that the variable delay (D) of width adjustment circuit 106 is adjusted in order to keep the pulse width error approximately equal to zero.

Assuming that the pulse width error is zero, the delay (Δt) can be determined according to the following equation:

$$Δ t = \frac{{V}_{P} ( ac )}{{V}_{p} ( ac + dc )} {PW}_{REF} \qquad ( 2 )$$

In this instance, the delay is proportional to the ac components of the supply voltage (V_{P}), which ac components are compensated by loop filter 608 weighted by the sum of ac as well as dc components.

Circuit 600 provides a number of advantages. First, since the delay is based on the accumulated signal error, the delay stage within the loop filter 608 is not critical. Further, the V_{P}(dc+ac) component can be obtained by a current generated by the voltage-to-current converter with feedback 112 and the reference voltage component (I_{REF}) is substantially equal to V_{REF}/R₃₀₆. Thus, circuit 600 depicted in FIG. 6 reduces circuit complexity and cost.

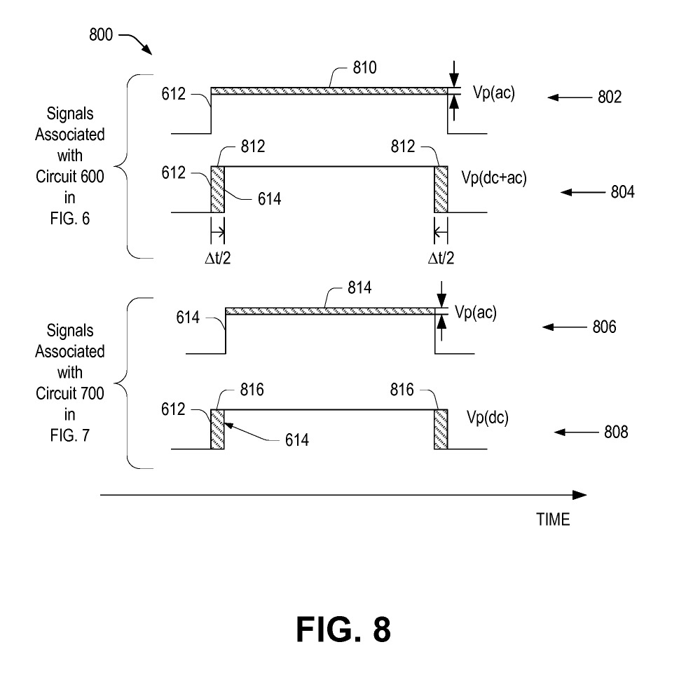

While feedback circuit 600 uses the compensated input signal (PW_{REF}) to integrate the supply voltage (V_{P}(ac)) signal, it should be understood that other signals may be used to control the integration timing. A particular example is described below with respect to FIG. 7, where the compensated signal (PW) 614 is used to integrate the V_{P}(ac) signal.

FIG. 7 is a block diagram of an embodiment of a circuit 700 configured to adjust pulse widths of a signal based on a compensated output signal 614. Circuit 700 is the same as circuit 600 in FIG. 6, except that integrator 604 integrates the dc components of the supply voltage (V_{P}(dc)) with the delay (Δt), and integrator 606 integrates the supply voltage (V_{P}(ac)) based on the compensated output signal (PW) 614 instead of the uncompensated input signal (PW_{REF}) 612. In this example, the summing device subtracts the output from integrator 604 from the output of integrator 606 to produce the pulse width error and provides it to loop filter 608.

In operation, integrator 604 integrates the dc components of the supply voltage (V_{P}(dc)) over the delay (Δt) to produce a first output, and integrator 606 integrates the ac components (V_{P}(ac)) of the supply voltage over the width of the compensated output signal (PW) 614 to produce a second output. As discussed below with respect to FIG. 8, either configuration (i.e., circuit 600 or circuit 700) can be used to provide feedback compensation for the ac component. An example of the integrated signals is described below with respect to FIG. 8. One advantage provided by circuit 700 is that, if the voltage-to-current converter with feedback 112 is used, only one variable current needs to be provided, while all of the other currents are constant and equal to or proportional to the reference voltage (V_{REF}) divided by the value of a resistor, such as resistor 306 in FIGS. 3 and 4.

In the illustrated embodiments of FIGS. 6 and 7, it should be understood integrators 604 and 606 may include voltage-to-current converter with feedback 112 or that the voltage-to-current converter 112 may be placed in front of integrators 604 and 606. In such a case, it should be understood that the signal (V_{P}(ac+dc)) represents the second current (I_{P2}) depicted in FIGS. 3 and 4, and the signal (V_{P}(ac) represents the difference between the second current (I_{P2}) and the reference current (V_{REF}/R₃₀₆). Further, the signal (V_{P}(dc)) represents the reference current.

FIG. 8 is a timing diagram 800 depicting the relatively high frequency (ac) and relatively low frequency (dc) signal components of the pulse widths in the embodiments of the circuits depicted in FIGS. 6 and 7. Timing diagram 800 depicts signals 802 and 804 associated with circuit 600 in FIG. 6, and signals 806 and 808 associated with circuit 700 in FIG. 7. Note that the gain of the loop filter 608 in FIGS. 6 and 7 is large and forces the dashed area 812 (814) to be equal to the dashed area 812 (816) by modifying the delay (Δt).

Signal 802 is a pulse corresponding to the output of the integrator 606 in FIG. 6, which represents the difference between the second current (IP2) and the reference current (V_{REF}/R₃₀₆) integrated over the duration of the pulse of the PW_{REF} signal 612. Signal 804 is a pulse that corresponds to the output of integrator 604 in FIG. 6, which represents the second current (I_{P2}) integrated with the delay determined by phase detector 602. The difference in time for each of the edge transitions of the signal 804 is weighted as described above with respect to Equation 2. The area of the “hashed” portion 810 of signal 802 is substantially equal to the sum of the areas of hashed portions 812 of signal 804.

Signal 806 corresponds to the output of integrator 606 in FIG. 7, which represents the difference between the second current (IP2) and the reference current (V_{REF}/R₃₀₆) integrated over the duration of the pulse of the PW output signal 614. Signal 808 is a pulse that corresponds to the output of integrator 604 in FIG. 7, which represents the reference current (I_{REF}=V_{REF}/R₃₀₆) integrated with the delay determined by phase detector 602. Once again, the area of the “hashed” portion 814 of signal 806 is substantially equal to the sum of the areas of hashed portions 816 of signal 808. In either case, the pulse width correction (Δt) provided by the loop filter 608 is the same; therefore, the two circuits 600 and 700 of FIGS. 6-7 are equivalent where the loop filter gain is large.

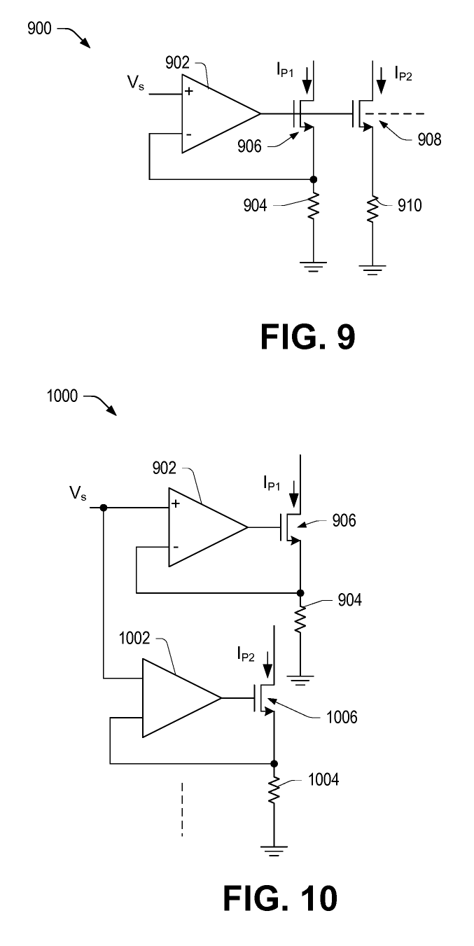

FIG. 9 is a diagram of an embodiment of a transconductance circuit 900 configured to receive a scaled voltage signal (Vs) and to generate first and second currents (I_{P1} and I_{P2}) using a current mirror configuration, which can be used to implement transconductance stage 304 illustrated in FIGS. 3 and 4.

Transconductance circuit 900 includes an operational amplifier 902 including a positive input to receive the scaled voltage signal (Vs) and a negative input connected to a first terminal of a resistor 904, which has a second terminal connected to ground. Operational amplifier 902 also includes an output connected to a gate of transistor 906, which has a drain for carrying a first supply current (I_{P1}) and a source connected to the first terminal of the resistor 904 and to the negative input.

As shown, one or more additional transistors, such as transistor 908 can be connected to transistor 906 to provide a current mirror for producing one or more additional currents that are proportional to the first supply current (I_{P1}), such as second current (I_{P2}). Transistor 908 includes a drain for carrying the second current (I_{P2}), a gate connected to the gate of transistor 906, and a drain connected to a first terminal of resistor 910, which has a second terminal connected to ground. It should be appreciated that additional transistors and resistors may be provided in a similar configuration to provide additional currents, which may be supplied to other circuits, such as the ramp generators 502 and 504 in FIG. 5.

In operation, the output of operational amplifier 902 substantially tracks the voltage signal (Vs) at the positive input minus the voltage at the negative input. Thus, fast, but small changes in the voltage signal (Vs) will be provided to the amplifier output in a substantially linear fashion, providing a substantially linear gain that tracks the voltage signal.

In a particular embodiment, the second current (I_{P2}) can be applied to a sense resistor, such as resistor 306 depicted in FIGS. 3 and 4, to produce a sense voltage for comparison to a reference voltage as described above with respect to FIGS. 3 and 4, provided (as mentioned above) that resistor 306 is connected to a supply terminal (V_{DD}) rather than ground. Alternatively, transistors 906 and 908 can be implemented as PMOS transistors and the positive and negative inputs of operational amplifier 902 can be switched to provide similar functionality and allowing resistor 306 to remain connected to ground. As previously mentioned, additional currents may also be generated for driving other circuitry, such as currents (I_{P2} and I_{P3}) for driving ramp generators 502 and 504 in FIG. 5.

FIG. 10 is a diagram of a second embodiment of a transconductance circuit 1000 configured to receive a scaled voltage signal (Vs) and to generate first and second currents (I_{P1} and I_{P2}) using a parallel amplifier configuration. Circuit 1000 includes operational amplifier 902, transistor 906, and resistor 904 as described above with respect to FIG. 9. Circuit 1000 further includes a second operational amplifier 1002 including a positive input connected to the first input of amplifier 902 and a negative input connected to a first terminal of resistor 1004, which includes a second terminal connected to ground. Operational amplifier 1002 includes an output connected to a gate of transistor 1006, which includes a drain for carrying second current (I_{P2}), and a source connected to the first terminal of resistor 1004 and to negative input of the operational amplifier 1002. Additional currents may be generated by adding one or more current mirrors or additional amplifier stages.

Upon review of circuits 900 and 1000, it should be appreciated that the first and second currents (I_{P1} and I_{P2}) may be substantially identical. However, depending on the implementation, transistors 908 and 1006 may be designed to carry a second current (I_{P2}) that is proportional to the first current (I_{P1}). In a particular embodiment, the second current (I_{P2}) is a copy of the first current (I_{P1}) and additional currents that are proportional to the first current (I_{P1}) are also provided through other legs of the current mirror or through additional amplifier circuits.

In conjunction with the circuits described above with respect to FIGS. 1-10, a voltage-to-current converter with feedback is disclosed, which can be used as a transconductance stage and/or as a high pass filter. The voltage-to-current converter includes a PGA to receive a voltage signal and to produce a scaled voltage signal. Voltage-to-current converter further includes a transconductance stage to produce a first current based on the scaled voltage signal and a second current that is proportional to the first current. Voltage-to-current converter also includes a summing device to produce an analog error (eₐ) based on a difference between a sense voltage derived from the second current and a reference voltage, a comparator (such as an analog-to-digital converter) to convert the analog error (eₐ) into a digital error (e_{d}), and a feedback loop configured to generate a gain adjustment signal based on the digital error. The voltage-to-current converter is designed to convert voltage signal input noise into a current signal with better than approximately 0.1% linearity where the power supply drifts, for example, due to batter discharge. In a particular embodiment, the compensation provided by the voltage-to-current converter is used to modify a signal pulse width.

Although the present invention has been described with reference to preferred embodiments, workers skilled in the art will recognize that changes may be made in form and detail without departing from the scope of the invention.

1. A voltage-to-current converter comprising:
a transconductance stage including an input configured to receive a scaled voltage signal, a first output to carry a first current based on the scaled voltage signal, and a second output to carry a second current that is proportional to the first current; and
a digital feedback loop coupled to the second output of the transconductance stage and configured to adjust the scaled voltage signal based on an error between an external reference voltage and a sense voltage derived from the second current to compensate for changes in the scaled voltage signal.

2. The voltage-to-current converter of claim 1, wherein the voltage-to-current converter is characterized as having a high pass filter response.

3. The voltage-to-current converter of claim 1, wherein the voltage-to-current converter is configured to operate as an analog-to-digital converter with embedded low-pass filtering.

4. The voltage-to-current converter of claim 1, wherein the digital feedback loop comprises:
a resistor coupled to the second output and configured to sink the second current to generate the sense voltage;
a summing device configured to determine the error based on a difference between the external reference and the sense voltage;
an analog-to-digital converter to convert the error into a digital code; and
a loop filter configured to process the digital code to produce a gain adjustment signal.

5. The voltage-to-current converter of claim 4, wherein the analog-to-digital converter has a resolution of one-bit.

6. The voltage-to-current converter of claim 4, further comprising:
a programmable gain amplifier (PGA) including an input for receiving a voltage signal and responsive to the gain adjustment signal to apply a gain to scale the voltage signal to produce the scaled voltage signal.

7. The voltage-to-current converter of claim 6, wherein the gain adjustment signal is a multi-bit control word.

8. The voltage-to-current converter of claim 1, wherein the digital feedback loop comprises:
a resistor coupled to the second output and configured to sink the second current to generate a sense voltage;
a summing device configured to determine the error based on a difference between an external reference and the sense voltage;
a comparator configured to convert the error into a feedback error; and
a loop filter configured to process the feedback error to produce a gain adjustment signal.

9. A voltage-to-current converter comprising:
a programmable gain amplifier (PGA) including an input for receiving a voltage signal and including a control input, the PGA responsive to a gain adjustment signal at the control input to adjust a gain and to apply the gain to the voltage signal to produce a scaled voltage signal;
a transconductance stage for receiving the scaled voltage signal, the transconductance stage including a first output for carrying a first current based on the scaled voltage signal and including a second output for carrying a second current proportional to the first current;
a comparator configured to generate a digital error signal by comparing a voltage threshold to a difference between an external reference voltage and a sense voltage derived from the second current; and
a digital loop filter coupled to the comparator and to the control input, the digital loop filter configured to generate the gain adjustment signal to adjust the gain to reduce the difference to approximately zero based on the digital error signal.

10. The voltage-to-current converter of claim 9, wherein:
the comparator comprises an analog-to-digital converter characterized as having a resolution of one bit; and
the gain adjustment signal includes a multi-bit control word.

11. The voltage-to-current converter of claim 9, wherein the transconductance stage comprises:
an operational amplifier including a positive input for receiving the scaled output voltage, a negative input, and an amplifier output;
a transistor including a drain coupled to an output of the system for providing the first current, a gate coupled to the amplifier output, and a source coupled to the negative input of the amplifier; and
a resistor including a first terminal coupled to the source and a second terminal coupled to a power supply terminal.

12. The voltage-to-current converter of claim 11, further comprising:
a second transistor including a drain for providing the second current, a gate coupled to the gate of the transistor, and a source; and
a second resistor including a first terminal coupled to the source of the second transistor and a second terminal coupled to the power supply terminal.

13. The voltage-to-current converter of claim 11, further comprising:
a second amplifier including a positive input for receiving the scaled output voltage, a second input, and an amplifier output;
a second transistor including a drain for providing the second current, a gate coupled to the amplifier output of the second amplifier, and a source coupled to the second input of the second amplifier; and
a second resistor including a first terminal coupled to the source of the second transistor and a second terminal coupled to the power supply terminal.

14. The voltage-to-current converter of claim 9, further comprising:
a summing device including a first input coupled to the second output for receiving the sense voltage, a second input for receiving the reference voltage, and an output for providing an analog error that is a difference between the sense voltage and the reference voltage; and
a dither circuit coupled to the second input of the summing device and configured to inject noise into the reference voltage.

15. A circuit comprising:
a programmable gain amplifier (PGA) including an input for receiving a supply voltage and a control input, the PGA configured to apply a gain to the supply voltage to produce a scaled output voltage;
a transconductor for receiving the scaled output voltage, the transconductor including a first output for carrying a supply current based on the scaled output voltage and including a second output for carrying a second current proportional to the supply current;
a comparator configured to generate an error signal based on a voltage threshold and a difference between an external reference voltage and a voltage derived from the second current; and
a loop filter coupled to the output of the summing device and to the control input, the loop filter adapted to generate a control signal to adjust the gain of the PGA based on the error signal.

16. The circuit of claim 15, further comprising:
an analog-to-digital converter responsive to the error signal for generating a digital error code.

17. The circuit of claim 16, wherein the loop filter comprises a digital loop filter configured accumulate the error and to produce a gain adjustment signal for controlling the PGA.

18. The circuit of claim 15, wherein:
the error has a one-bit resolution; and
the PGA is responsive to a multi-bit control word to adjust the gain.

19. The circuit of claim 15, wherein:
a gain characteristic of the PGA is substantially non-linear; and
a gain characteristic of the transconductor is substantially linear.

20. The circuit of claim 15, further comprising:
a dither circuit configured to dither the external reference voltage by an offset.
